(19) United States
(12) Patent Application Publication
(10) Pub. No.: US 2006/0013940 A1
(43) Pub. Date: Jan. 19, 2006

(54) Food items based on starch networks

(76) Inventors: Rolf Mueller, Zurich (CH); Federico Innerebner, Zurich (CH)

Correspondence Address: JORDAN AND HAMBURG LLP, 122 EAST 42ND STREET, SUITE 4000, NEW YORK, NY, 10168, US

(21) Appl. No.: 10/527,545

(22) PCT Filed: Sep. 12, 2003
(86) PCT No.: PCT/CH03/00616

§ 371 Date: Mar. 10, 2005

(30) Foreign Application Priority Data
Sep. 13, 2002 (WO) PCT/EP02/10345

(51) Int. Cl. A23G 3/00

(52) U.S. Cl. 426/658

(57) ABSTRACT

A wide range of foods, such as pasta products, cereals, snacks, pastry and the like, based on starch networks specifically adjusted to respective foods, which makes it possible to manufacture such foods from a larger selection of raw materials relative to the prior art, and also to improve product characteristics, such as the chewing consistency of pasta products, the crispness of cereals, snacks and pastries, and their tolerance relative to humid atmosphere. In addition, such foods based on starch networks can be manufactured with a resistant percentage fabricated in situ and a reduced glyceamic index. Also characteristic of the foods is that, during manufacture, they have a molecularly disperse mixture of networkable starch with an additional starch, and this mixture forms a network before potential separation.

The invention describes a wide range of foods based on starch networks, such as pasta products, cereals, snacks, pastry and the like, with advantageous properties, which are rooted in nature and the adjustability of the starch networks, and can essentially be manufactured with any kind of starch, flour, semolina and the like.

The object of the invention is to provide the cited foods, wherein these foods here have at least one, and preferably all of the following characteristic features:
1. A starch network having a wide variability with respect to the starch components constituting the network and the network density, making it possible to specifically adjust essential product properties, such as texture, cooking or baking behavior, crispiness, along with stability in aqueous media and in a humid atmosphere, and optimize them for the respective foods;
2. Except for a small percentage of network-capable starches, high degree of independence from the type and quality of starch-containing raw materials used, i.e., the ability to manufacture high-quality pasta products out of lower-quality hard wheat, bread wheat, and also out of any kind of starch, flour and whole wheat, semolina and the like;
3. Functional properties that can be adjusted with the network parameters, e.g., a percentage of starch resistant to amylase, which is formed in situ during or after food manufacture, as well as a glyceamic index in relation to conventional foods.

### PRIOR ART WITH RESPECT TO PASTA PRODUCTS

Pasta products are generally understood to be processed foods containing starch, flour, semolina and the like, which are prepared for consumption in hot or boiling water, during which they become soft, while still exhibiting a certain dimensional stability and cohesion. Typical examples include pasta and multitudinous variety thereof, such as macaroni, spaghetti, noodles, spaetzle, lasagna, ravioli, tortellini, tagliatelle, ziti, as well as gluten-free or gluten-reduced pasta products and South American, Oriental and Asian pasta products, such as cuscus, glass noodles, rice sticks, vermicelli, Chinese, Japanese, Thai and other typical regional pasta products.

Prior art relative to pasta products essentially encompasses the following technologies:

1. Traditional pasta is made exclusively based on high-quality hard wheat flour (granum durum, semolina), as well as based on certain high-quality bread wheat varieties. In particular the percentage and quality of the gluten content in the raw materials is critical for the product properties of the pasta. The gluten, also known as vegetable gluten, acts as a binder, i.e., as a matrix, so that the starch granules are permanently bound together, thereby preventing or delaying any disintegration of the pasta during the cooking process.

One characteristic feature of the pasta industry is that it offers nutrition very rich in tradition. For a long time, technology experienced virtually no groundbreaking changes. Even today, it still involves three basic preparation steps: mixing of component (dough preparation), shaping, drying of pasta products.

Hard wheat and water are traditionally homogeneously mixed in a mixing aggregate. The two components must here be uniformly distributed without damaging the grain structure of the starch. A slightly inhomogeneous distribution of water results in poor quality (spots). Disrupting the grain structure in turn results in poor chewing behavior and poor resistance to boiling. Shaping with profile dies is followed by a drying process.

One important trend in the classical pasta industry is moving toward improved and consistent quality. In particular resistance to boiling, improved chewing behavior and reduced stickiness are clear requirements.

In the last 10 to 15 years, the pasta industry has been undergoing a vigorous technological development from the discontinuous batch process to continuous preparation. The process of molding the mass into the desired shape (short or long product) could be improved in such a way as to achieve excellent surfaces of the molded pasta products, and this at output rates of several tons per hour.

The development of a drying process also helped to improve the quality and increasing the output while keeping costs low. The pasta was traditionally dried for 24 hours or more at temperatures of around 50° C. Today, the pasta can already be continuously dried in less than 5 hours at temperatures ranging from approx. 80-110° C. (HT, THT method) and at an elevated or controlled atmospheric humidity, achieving the best qualities possible in the process.

The various procedural improvements, in particular the HAT and THT drying methods and continuous mixing processes, have also helped make it possible to process lower-quality raw materials, i.e., wheat with poor gluten quality, into high-quality end products. Little is understood about the reason for this, although it is assumed that the amylose partially dissolved out of the starch grains while fabricating the pasta subsequently retrogrades during the drying process, and hence acts alongside the gluten as an additional support matrix, thereby yielding an improved cohesion.

2. Since only hard wheat and some soft wheat varieties have enough high-quality gluten to produce the desired texture and boiling properties of pasta, one first method for manufacturing pasta products based on raw materials with insufficient gluten, e.g., rye, barley, oats, spelt, and unripe spelt grain, or on raw materials that have no gluten, such as potatoes, tapioca, rice, corn, canna, buckwheat, and lentils, involves substituting the gluten with binders like xanthan, carrageenan, guar, carob meal or agar, so that entirely gluten-free pasta products can be produced. In light of the increasing worldwide gluten allergy (celiac disease, sprue: intolerance to glutenin, a constituent of gluten), there is a rising demand for such pasta products.

However, previous attempts often result in inadequate boiling properties, are visually unattractive and, due to the binder employed, have a distinctly unpleasant, strange taste and odor.

3. In a second method for fabricating pasta products out of other flours than Durum and soft wheat, pre-boiled or partially gelatinized flour or starch is used. In particular Asian pasta products like glass noodles are manufactured according to this method. Pre-boiling or gelatinizing releases some of the amylose from the starch grains and, under suitable conditions, this portion can be made to retrograde, resulting in a cohesion of pasta products while boiling. However, the corresponding methods are complicated (pre-boiling, gelatinization), and require the retrograding of longer conditioning times (maturing). The corresponding products also often exhibit poor boiling behavior, i.e., the strength and texture properties of the pasta products diminish very rapidly to inadequate levels while boiling (drawing 3).

During the manufacture of pasta products according to the invention, the processes for generating a support matrix out of starch, which can be used in batches for more recent methods for manufacturing pasta as well as for pasta products based on gelatinization, are being used to a much greater extent by means of new and specific preparation processes. This makes it possible to manufacture pasta products with any raw material, even with amylose-free starches and flours out of waxy grains, e.g., waxy corn or waxy rice, and independently of the gluten content, whose properties can be adjusted within a wide range independently of the raw material quality (e.g., gluten content, defective grain structure), which have a reduced stickiness due to extensive starch networks and, due to the temperature stability of these networks when boiled, can be obtained with chewing consistencies that even greatly exceed the required level (drawing 3). The independence of the used raw materials and their quality is important on the one hand, because high-quality pasta products can hence be manufactured with favorable raw materials. In addition, hard wheat is more expensive than soft wheat in most countries, and high-quality wheat is naturally more expensive than that of lower quality, while pasta products in Asia are often made out of expensive mung beans, and a demand exists for pasta products made from more favorable raw materials. On the other hand, the availability of grains varies from one region to another. Hard wheat is grown primarily in Canada and the U.S., in southern Europe, in particular in Italy at roughly 65% of the European hard wheat, in Russia and Kazakhstan, in Turkey and in North Africa, while other types of grain are planted in other regions and countries, either because the climatic conditions are unfavorable for hard wheat, or for traditional reasons. In developing countries, importing hard wheat poses financial problems, and there is an outspoken demand for manufacturing pasta products, which are a nutritional, healthy and extraordinarily durable food, out of local and favorable starch-containing raw materials. The new technology for manufacturing pasta products according to the invention makes it possible to take such regional details into account. Pasta products according to the invention can be made out of various types of grains, flours, unprocessed or whole wheat and starches, e.g., from rice, potatoes, sweet potatoes, tapioca, canna, peas, beans, lentils, sago, arrowroot, maranta, or from palm roots in a high quality sing favorable, local raw materials and in cost-effective processes.

### PRIOR ART FOR CEREALS, SNACKS AND PASTRIES

Cereals or cereals and snacks include both flaked cereals like Corn Flakes or Frosties, along with puffed, i.e., expanded cereals like Weizen Snacks or Crisp Reis, and other cereal and snack types like chips, sweet and salty snacks, doughy snacks, tacos or dips, as well as crackers, waffles or cookies. Pastry includes both bread and bread products along with other products made of dough, such as pizza dough, crepes and the like. Ethnic foods like tortillas, enchiladas, arepas, panquecas or cachapas are difficult to classify, but are also suitable for the use of starch networks.

A large number of different methods exist in these food sectors. Continuous boiling extrusion is of particular importance, especially in the area of cereals and snacks. There are also various batch processes, such as steam boiling processes, wherein very long boiling times are in part used, e.g., during the manufacture of Corn Flakes, wherein valuable substances like vitamins are largely denatured. Cereal or Corn Flakes are today also manufactured by boiling extrusion, which is clearly more advantageous than the batch and rolling processes, but only yields modest qualities, as Corn Flakes become soft very rapidly in milk.

The use of starch networks is particularly suitable in boiling extrusion processes, wherein the NS is mixed in during the course of boiling extrusion, but this can also take place in a batch process. Except for NS preparation, which only comprises a small percentage of the end product, the corresponding processes can also take place at reduced and moderate temperatures, and short process times on the order of minutes are also made possible, so that denaturing can be countered. In addition to these advantages, the properties of starch networks makes it possible to also manufacture Corn Flakes via extrusion, wherein the crispiness is increase by comparison to high-quality Corn Flakes made in batch and rolling processes, and retained longer in milk. It is especially important in the case of puffed flakes and snacks that the starch network arises very fast, because the water content is quickly reduced in value, wherein the network formation prevents the network-capable mixture of NS and VS from becoming frozen in an amorphous state. However, the parameters of the technology for manufacturing foods based on starch networks make it possible to solve this set of problems by breaking up network formation shortly before foaming the snacks or flakes, and using short-chained NS with a DPn<300, preferably <150, which has a higher mobility.

### BRIEF DESCRIPTION OF THE INVENTION

The invention encompasses novel networks based on starch, which have advantageous properties in the area of foods. It incorporates the manufacture of such foods, the measures for setting up specific networks, which can be adapted for certain foods, and the resultant advantageous properties. The manufacture of foods according to the invention involves the following basic characteristics:

1. The use of a networkable starch (NS), which, under suitable conditions, can at least partially crystallize, and in so doing form networks, and/or can form networks with an existing starch (VS) if at least one is present, in which the links are comprised of crystallites formed at least in part via the heterocrystallization of molecules in the NS and VS, wherein the connection elements of these crystallites preferably consist of molecules or molecule segments of the VS.

2. At least the partial, preferably complete release of the crystallization potential of the NS, in particular by dissolving or plasticizing the NS, wherein measures like overheating, supercooling, incorporation of nucleation means are taken as required. Native starch grains have a structure partially ordered on various size scales. In the process of increasing gelatinization, a plurality of these ordered structures are irreversibly destroyed in succession. Even after complete gelatinization, however, the starch grains are still visible under a microscope as swollen, deformed, partially burst open structures, i.e., destructurization is not yet complete. A nearly complete, preferably complete destructurization of the starch grains is advantageous for completely and optimally releasing the crystallization potential, and hence the potential for generating networks. Large portions contained in residual structures result in reduced network densities. Given an optimal realization of crystallization potential to form advantageous networks, preceding complete destructurization yielded the highest network densities, and hence high-quality product properties. Distinctly higher temperatures of approx. 120-180° C. are required than for gelatinization (50-90° C.) in order to achieve complete destructurization. In the presence of shearing forces during plasticization, the necessary temperatures can be reduced, and the destructurization process can be significantly accelerated.

3. Mixing, in particular molecularly disperse mixing of at least one NS prepared according to step 2 with at least one VS. An Ystral mixing aggregate is suitable for this purpose, for example. To this end, the VS must also be in a dissolved, or at least partially plasticized, state. A molecularly disperse, i.e., networkable mixture of these components is a precondition for especially advantageous networks formed at least partially through heterocrystallization. The starch macromolecules of the NS and VS are here brought in close proximity to each other, thereby enabling the subsequent heterocrystallization. During the mixing process, which is both distributive and dispersive, adequate shearing forces are necessary. This mixture of NS and VS, which consist of various macromolecules that can in particular vary greatly in terms of molecular weight, is thermodynamically unstable; the separated state is the stable state. As is generally known, even chemically identical macromolecules that differ in molecular weight are difficult to mix together, and even when this does happen, they quickly separate again (phase separation). In addition to molecular weight, the NS and VS starches to be mixed also differ in terms of structure, wherein NS are primarily linear, and VS are primarily branched. To enable use of the molecularly disperse, mixed state for network formation, the mixture must be kept in a state of disequilibrium until network formation sets in. This is accomplished by using sufficient shearing forces, and short processing times typically measuring seconds to minutes between the manufacture of the mixture and the onset of network formation. After network formation is complete, the starch network as a support matrix can function as a binder, and be used in various food applications, e.g., as a binder in place of gluten in pasta based on gluten-free or low-gluten flour, semolina or starch, wherein the binder is hereby mixed and the mixture processed into the end product. In gluten-containing raw materials, in particular Durum and soft wheat, the starch network can be used to enhance the gluten matrix, as a result of which the texture properties of these products can be varied in an expanded range relative to prior art.

With respect to mixing the NS and VS, a distinction is made between three procedural variants, wherein different mixing forms of these variants are conceivable. The only key factor in all procedural variants, however, is that a networkable mixture of NS and VS be present during molding at the latest:

3.1. The mixture of NS and VS is a mixture between at least one NS and at least a first VS (VS1), wherein the NS can be prepared, i.e., destructured, together with the VS1 or separately from the VS 1. The networkable mixture of NS and VS then forms the starch network in the end product, i.e., the support matrix for at least one second VS (VS2), which normally represents the main constituent of the end product. If the NS and VS 1 are separately prepared, they can be mixed with the VS2 either separately or in sequence. In addition, VS1 can be supplied to the mixing process with NS, with VS2 or with already mixed NS and VS2 in a non- or partially destructured state. However, it must here be ensured that at least a partial destructurization takes place subsequently, for example, due to shearing forces during the mixing process. The process water can be routed to the process in varying portions via at least one of the prepared or wetted main component, as well as independently of the main components.

In this procedural variant, in which VS1 is used, a molecular disperse mixture of at least NS and VS1 is generated during the process, while VS2 can be present after molding in a non-destructured to completely destructured, preferably in a partially to completely gelatinized state. If the VS2 is present in a non-destructured state, the binder forming the support matrix consists exclusively of the mixture of NS and VS1, and the product has a two-phase system. If VS2 is present in a partially to completely gelatinized state, the support matrix consists primarily of the mixture of NS and VS1, and the product also ahs a two-phase system, wherein the phase coupling is optimal, since the network consisting primarily of NS and VS1 is connected by shared macromolecules with the network that forms after the gelatinization of VS2, i.e., the phase transition is continuous. If VS2 is present in a partially to completely plasticized state, the support matrix consists of a mixture of NS, VS1 and VS2, and the product has a nearly homogeneous one-phase system given a partial plasticization of VS2, and a completely homogeneous one-phase system given a complete plasticization of VS2.

It is advantageous to use VS I if the employed VS2 has a high gelatinization temperature and/or if the process temperatures are to be kept low, for example to prevent Maillard reactions. In addition, it is possible when choosing VS1 to select raw materials that are particularly favorable for starch networks in combination with the selected NS, while the properties with respect to network formation of the main component VS2 need not be relevant. This makes it possible to expand the range of possibilities, and introduce another control parameter.

3.2. The mixture of NS and VS is a mixture consisting of at least one NS and at least a second VS (VS2), wherein no VS1 is used. In this case, the networkable mixture of NS and VS is generated while mixing the NS and VS2 by at least a portion of VS2 that is at least partially gelatinized, preferably at least partially plasticized, i.e., at least one component of the binder or the networkable mixture stems from the component VS2 to be bound in this procedural variant. VS2 can be partially to completely gelatinized before or during the process, wherein the product then has a two-phase system with optimal phase coupling, or is partially or completely plasticized, wherein a nearly or completely homogeneous one-phase system results. As with procedural variant 3.1, there are comparable possibilities relative to the supply of process water. The advantages to this procedural variant lie in the simplicity of the process, since no component VS1 must be taken into account. The scope is somewhat more limited relative to variant 3.2, but this limitation is not relevant for most applications.

3.3. The networkable phase consists only of NS. VS2 is not gelatinized either before or during the process. While a broad range of networkable starches is available in variants 3.1 and 3.2, the NS must have a polymerization degree DPn of at least 100 in this variant, so that the NS can also form a network in the absence of a VS. The product then has a two-phase system, wherein the phase coupling is not optimal. This variant is also easy, but also places greater limits on the scope. It is used in particular in cases where minimal requirements are placed on the texture of the food.

4. During or after molding of the entire mixture into the end product, the network formation is initiated by a reduction in temperature and/or water content (or evacuation shortly before molding, drying after molding). Subsequent conditioning or thermal treatment given a set progression of temperature T and relative atmospheric humidity RH as a function of time is essentially for establishing higher network densities and optimally converting the networkable mixture into networks. The optimal conditions are greatly dependent on the used NS, as well as on the water content of the food. At high water contents of about 40% (w/w) or more, high to very high network densities can be established via storage at RT for several hours. During storage over several hours at low temperatures of down to <0° C., very high network densities can also be obtained. At temperatures>RT, the achievable network densities taper off. However, the shortest possible conditioning times are important for commercial production. This can be achieved by setting the water content to <35% and using higher temperatures. The lower the water content, the higher the optimal conditioning temperature, so that conditioning can be executed while drying. The conditioning times can be kept short by using nucleation means, methods for supercooling the NS solution or melt, wherein crystal nuclei come about, as well as by using NS with polymerization levels of DPn<300, preferably <150, in particular <100.

Reference is made to Patent Application WO 03/035026 A2 of the same applicant with respect to NSN preparation, the relevant parameters and advantageous measures like overheating, supercooling and incorporating nucleation means, and advantageous methods and details relating to the manufacture of starch networks. Ystral mixing aggregates or extruders are suitable for manufacturing the mixture of NS and VS1, for example. In particular synchronous and tightly meshing two-screw extruders are suitable for manufacturing the overall mixture, if necessary with recirculating elements, or single-screw extruders with a distributive mixing part, e.g., with paddle mixing elements. Press extruders or gear pumps can be used to build up the pressure necessary for molding.

DIFFERENTIATION FROM CONVENTIONAL FOODS

While foods according to the invention with product properties comparable with conventional, similar products can be manufactured, it is also possible to use the starch networks as a basis for specifically varying and optimizing certain product properties. For example, new types of pasta products based on starch networks can be manufactured proceeding from white flour and any other flours, semolina or starches, which have much higher chewing consistencies than conventional hard wheat pasta (drawings 6 and 7).

Such high chewing consistencies are not necessary for pasta product applications, but the example clearly shows the potential variety of possibilities resulting from the starch network. While various optimizations are required for conventional hard wheat pasta, e.g., relative to the drying conditions or quality of hard wheat, in order to improve the chewing consistency, new pasta products based on starch networks can be manufactured using any flours, starches or semolina, regardless of their quality, yielding a chewing consistency that clearly exceeds the required chewing consistencies. With respect to chewing consistency, the mechanical properties of the new types of pasta products must be reduced to some extent, so that an optimal texture is achieved for this application. This is easily achieved by reducing the portion of networkable mixture in the overall product, e.g., by reducing the portion of NS and/or reducing the temperature and/or shearing forces while mixing prepared NS with second VS or, if needed, with first and second VS.

Even though foods based on starch optimized for pasta applications need not differ from conventional pasta relative to the boiling behavior, the above example clearly shows that the two products are fundamentally different.

The different approach is manifested most clearly in the behavior of foods based on starch networks in excess water at room temperature (RT). Conventional yellow hard wheat pasta gradually turns white, and is so soft after approx. 2 h that it crumbles easily when handled. After about three to four days, the water holding the hard wheat pasta becomes discernibly turbid, wherein the hard wheat pasta has an elastic modulus of <0.1 MPa; after about three days, gradual breakdown takes place. By contrast, pasta products based on starch networks can be manufactured with any flour desired. They swell comparably to hard wheat pasta or, depending on the network density and process parameters, e.g., water content during network formation, distinctly more, or distinctly less. After swelling is complete, the new pasta products have constant mechanical properties for days and even weeks on end, e.g., a elastic modulus in a tensile test of roughly 7 MPa, meaning a value at least 70 times higher in comparison to hard wheat pasta (Tables 2 and 3). In this case, no breakdown was observed, and the water around the new pasta products remains unchanged and clear; the pasta products are completely insoluble under these conditions (drawings 1 and 2). Their color depends on the used raw materials. When using starch, the product obtained can be colorless and completely transparent, wherein this transparence is retained even during storage in water at RT if the network density is high. At a low network density, a slight whitish discoloration is observed. When using flour, the color depends on the color of the flour.

While primarily the properties of the boiled product are relevant in the area of pasta products (long-term stability at RT in an aqueous environment is of interest, however, for fresh pasta products with a long shelf life or canned pasta products, for example), behavior at RT in an aqueous environment (milk) is key in the area of cereal flakes like Corn Flakes. The desired central product feature here is that the Corn Flakes remain crispy for as long as possible when eaten together with milk. While high-quality Corn Flakes already lose crispiness after 2-3 minutes, this time can be increased for Corn Flakes based on a starch network. Very high network densities advantageously come into play here, which yield too high a chewing consistency in the area of pasta products.

Advantages to Foods according to the Invention based on Starch Networks

1. The mentioned networks can be manufactured with any VS, without any limitation regarding the selection of VS1 and VS2. For example, pasta products can be manufactured with any starches, flours, semolina and the like, regardless of the presence of a portion of gluten or other binder, such as guar, xhanthan, carrageenan, carob meal, etc. In addition to selecting a suitable NS, the process and its parameters, the key for generating advantageous starch networks in particular involves the optimal release of the crystallization potential of the NS and optimal conversion of the crystallization potential into advantageous networks.

2. The network density of the starch network can be varied within a wide range via the portion of NS, the process parameters and, if necessary, while conditioning after the food has been molded, and also, if necessary, via the parameters of the drying process, which makes it possible to achieve specific properties of the food. For example, the texture, strength boiling time, chewing consistency or long-term stability of pasta products can be set to desired values as a result, in particular with respect to fresh pasta products and canned pasta products.

3. The temperature stability of the crystallites forming the linking points of the network can be adjusted by selecting suitable NS and adjusting the process parameters. This provides way s for setting the breakdown of the network in water at a specific temperature. In particular, crystallites can be obtained that remain stable even in boiling water. Especially in the case of Asian noodles, whose cohesion is rooted in the gelatinization of the used flours or starches, stability is often problematical when boiling, and the chewing consistency drops off too sharply and excessively after a short time.

4. As a result of the network structure, the breakdown of foods is delayed to incomplete during exposure to amylases in the digestive tract. Sensitivity to amylases in the digestive tract can be specifically influenced by setting the type and density of the network. A delayed breakdown causes a reduction in the blood sugar level peak (glyceamic index) after consumption of the food, while incomplete breakdown can be traced to a portion of resistant starch. As a result, the glyceamic index and resistant portion can be specifically influenced in foods according to the invention, and functional, healthy foods can be obtained. High glyceamic indices facilitate diabetes and obesity, and various other harmful effects on the body are currently still being discussed and analyzed by the experts. Therefore, there exists a proven demand for foods with a reduced glyceamic index. Resistant starch is known to be healthy, in particular to exert a prebiotic effect. Foods according to the invention were found to contain 8-13% resistant starch, for example. The functional properties of the reduced glyceamic index.

5. As known, the crispiness of Corn Flakes, snacks and pastry can be positively influenced by adding a portion of starch (high-amylose-containing starches, resistant starches) with elevated crystallinity. Since the network elements of starch networks in the foods according to the invention consist of crystallites, but these are not incorporated as an additive, but arise in situ, and these crystallites are additionally crosslinked, the network density can be used to regulate, in particular maximize, the crispiness of these foods to a greater extent. This yields advantages in cereals, snacks, chips and the like if these products are manufactured based upon the described starch networks.

6. Cereal flakes, snacks, chips and the like lose their crispiness and freshness relatively quickly in a humid atmosphere. Since water absorption from the atmosphere (sorption) is reduced and there is a higher tolerance relative to water absorption from the atmosphere due to the crystalline portion and network structure, the crispiness and freshness of foods according to the invention based on starch networks is retained for a longer period of time.

7. The use of starch networks in foods essentially provides for greater flexibility in setting specific product properties. Additional degrees of freedom in comparison to conventional foods include the share of starch network, the shares of VS1 and, if necessary, VS2, and parameters for network formation, such as time, temperature and water content. In addition, the new degree of freedom enables the use of new, particularly favorable and shorter manufacturing processes. Finally of note is that the new technology is essentially based upon physical processes, meaning that no chemical processes must be used, which is important in terms of accepting the corresponding food.

Even if to differing extents, the mentioned advantages are basically relevant for all foods according to the invention, such as pasta products, cereals, snacks, pastries and the like.

Primary Starches

Primary starches (VS or VS1 and VS2) include starches, flours, semolina and the like of whatever origin, along with mixtures of such raw materials, wherein their quality is not of primary importance. They can be obtained from the following plants, for example:

Corn, wheat, buckwheat, barley, rye, spelt, oats, sorghum, maranta, rice, potatoes, sweet potatoes, manioka, tapioca, cassava, arrowroot, yams, sago, beans, lentils, mung bean, peas, legumes, unripe bananas.

The different varieties and regional sorts in particular are also of importance. Examples include hard wheat (durum, hard red winter, hard red spring, hard white wheat), soft wheat (soft red winter, soft white wheat), waxy potatoes, waxy corn, waxy rice, waxy wheat, waxy sorghum, and varieties with an elevated amylose content, e.g. high-amylose-content corn (e.g., 50%, 70%, 90% amylose).

Other existing starches can include modified starches and flours. Modification can take place in a physical and/or chemical process.

Examples of physical modification include pre-gelatinization, thermal inhibition, spray drying, freeze-drying or roasting. Examples of chemical modification include esterification, etherification, cross-linking, breakdown with acids or amylases. Modified starches used in the foods industry (E Nos. 1404, 1410, 1412, 1413, 1414, 1420, 1422, 1440, 1442, 1451, 1450) are mainly employed as additives to modify the texture and boiling properties. For example, an elastic texture can be set by using a portion of hydroxypropyl distarch adipate or acetylated distarch adipate.

Primary starches VS1 are at least partially plasticized or partially dissolved in the course of manufacturing the foods, while existing starches VS2 can be present in the end product in any state between the native state and completely destructured state in procedural variant 3.1. By contrast, VS3 is present in a partially gelatinized state in procedural variant 3.2.

Networkable Starches NS

Various types of networkable starches can be characterized as follows.

1. According to a first definition, an NS can be a starch or flour of any origin, which can form gels or networks under suitable conditions. This excludes gels such as pure amylopectin gels, which require very long gelatinization times (days to weeks), and then only form very weak gels. Starches that form moderate to strong gels are preferred. The gelatinization capacity of starches can be enhanced via acid hydrolysis, for example (acid thinned starches). Such hydrolyzed starches as typically used in the area of confectionary also have a reduced molecular weight, which is especially advantageous, since this can accelerate the kinetics of network formation, making it easy to obtain high network densities.

1A. One group of starches that satisfies this requirement consists of native or modified starches with an amylose content of >15%, preferably of >20%, even more preferred of >30%, especially >40%, and most preferred >50%. High-amylose-content starches are particularly well suited, especially high-amylose-content corn starches, which can have an amylose content of up to nearly 100%, pea starches with amylose contents exceeding 25%, and amyloses of whatever origin desired. NS with high amylose contents can preferably be used in a pre-gelatinized or spray-dried state.

1B. Another group of NS can be obtained via chemical and/or enzymatic breakdown, in particular via debranching. Starches can be enzymatically broken down using amylases, such as α-amylase, β-amylase, glucoamylase, α-glucosidase, exo-α-glucanase, cyclomalto-dextrin, glucanotransferase, pullulanase, isoamylase, amylo-1,6-glucosidase or a combination of these amylases. In particular pullulanase is suitable for debranching, e.g., Promozymes of Novozymes.

Basically any kind of VS can be used as the parent material for breakdown purposes, wherein NS from one of the groups listed here is preferably used for this purpose, or dextrins, in particular maltodextrins, wherein the dextrins and maltodextrins were obtained from some VS or NS. Hydrolysis with acids, such as hydrochloric acid, is an example for the chemical, non-enzymatic breakdown of starches.

2. A next group of NS has branching levels of <0.01, preferably <0.005, even more preferably <0.002, most preferably <0.001, in particular <0.0001, wherein a distinction is made between the following types of NS relative to molecular weight or polymerization levels:

2A. Low-molecular NS (NNS): NNS is used to designate short-chained starches, which can crystallize after dissolved. They can be partially branched or primarily linear (short chain amylose). They can form networks via heterocrystallization in the presence of higher-molecular starches, which can be either not networkable or networkable. Of interest with regard to this type of low-molecular NS are starches with an average chain length CL or an average polymerization DPn ranging from 7 to 100, preferably from 7 to 70, even more preferably 7 to 50, in particular 7 to 30, most preferably from 7 to 25, and most particularly from 7 to 20.

NNS can be obtained, for example, via the chemical and/or enzymatic debranching of VS, in particular of dextrins or maltodextrins derived from VS, wherein the VS has an amylose content of <25%, preferably <20%, more preferably <15%, in particular <10%, most preferably <5% (waxy starches). Typically used as parent materials are potato starches, tapioca starches and waxy starches (e.g., waxy corn, waxy potatoes, waxy rice). Other examples include linear dextrins, amylodextrins, Natgeli dextrins.

2B. Moderate molecularNS (MNS): MNS is used to designate primarily linear starches, which can form networks alone or in combination with other starches, and have average polymerization levels DPn ranging from about 100 to 300.

NNS can be obtained, for example, via the enzymatic debranching of VS, in particular of dextrins or maltodextrins derived from VS.

2C: High-molecular NS (HNS): HNS is used to designate primarily linear starches, which can form networks along or in combination with other starches, and have average polymerization levels DPn measuring above about 300.

Distinguishing between NNS, MNS and HNS is important with regard to the properties of the starch network based on these components, and to processing. NNS can form networks even at low softener contents and low temperatures, MNS at moderate softener contents and moderate temperatures, while HNS requires comparatively higher softener contents and higher temperatures.

3. On the other hand, NS can be characterized in that the macromolecules contain linear portions, wherein these linear portions can be primary or side chains with average polymerization levels DPn >30, preferably >50, most preferably >80, in particular >100, most particularly >140. This is equivalent to the condition that the average chain length CL is >30, preferably >50, most preferably >80, in particular >100, most particularly >140.

4. In addition, another group of NS can be obtained by fractionating amylose-amylopectin mixtures, for example through fractionation via differential alcohol precipitation, wherein the amylose and intermediate fraction can be used as a networkable starch.

NS is used to designate starches that satisfy at least one of conditions 1 to 4. Physically and/or chemically and/or enzymatically modified starches derived from the NS in groups 1 to 5 are here included. Networkable starches also refer to mixtures, wherein the components therein and/or the mixture satisfies at least one of the conditions above. Suitable networkable starches that can be declared to be “starches” are available on the market, i.e., it is not absolutely necessary to use “modified starches” for manufacturing foods based on starch networks.

Additives Aids and Product Variations

Additives and aids are used to improve processability, influence network formation and modify product properties. In this regard, reference is made to Patent Application WO 03/035026 of the same applicant.

In addition, use can be made of food additives of the kind employed for the respective foods in prior art, e.g., emulsifiers, stabilizers, food acids, dyes, fragrances, spices and salt, of course also in foods based on starch networks.

Comparably to the prior art, different product variations can also be manufactured for the corresponding foods based on starch networks in the area of pasta products, e.g., vegetable pasta products, egg pasta products, pasta products enriched with protein, e.g., with soy, or pasta products containing additives, e.g., fibers, trace elements, vitamins, folic acid, thiamin, riboflavin, niacin. Further, as in prior art, the corresponding products can be obtained in varying states, e.g., as a durable foods, instant preparation, fresh product or canned good.

### EXAMPLES

Table 1 presents examples of foods based on starch networks, while Tables 2 and 3 along with FIG. 1 to 10 present the properties of the products.

TABLE 1
Examples for pasta products made of different flours,
starches and grits based on starch networks.

| | | | | VS1 | | NS |
|---|---|---|---|---|---|---|
| Nr. | VS2 | von | VS1 | [%] | NS | [%] |
| PG1 | Potato Starch pregelatinised | Avebe | — | — | NS-1 | 10 |
| PG2 | Potato Starch pregelatinised | Avebe | — | — | NS-1 | 10 |
| P14/10 | Corn Meal precooked | Venezuela | Corn Starch | 20 | NS-2 | 5 |
| | (for Arepas and Empanadas) | | | | | |
| P15/3 | Potato Starch | Cerestar | Potato Starch | 17.5 | NS-2 | 2.5 |
| P15/4 | Corn Starch | Cerestar | Potato Starch | 17.5 | NS-2 | 2.5 |
| P15/5 | Tapioca Starch | Cerestar | Wheat Starch | 17.5 | NS-2 | 2.5 |
| P15/6 | Wheat Starch | Cerestar | Potato Starch | 17.5 | NS-2 | 2.5 |
| P17/1 | Potato Whole Meal | Biorex | Potato Starch | 17.5 | NS-2 | 2.5 |
| P19/1 | Potato Starch pregelatinised | Avebe | — | — | NS-3 | 10 |
| P19/2 | Potato Starch pregelatinised | Avebe | — | — | NS-1 | 5 |
| P19/3 | Corn Starch pregelatinised | Roquette | — | — | — | — |
| P19/5 | Potato Starch pregelatinised | Avebe | — | — | NS-4 | 5 |
| P19/6 | Corn Starch pregelatinised | Roquette | — | — | NS-1 | 5 |
| P19/7 | Wheat Flour | Coop | Potato Starch | 27 | NS-1 | 3 |
| P19/8 | Potato Whole Meal | Biorex | Modified Starch 1 | 27 | NS-1 | 3 |
| P19/9 | Maranta/Tapioca Flour | Biorex | Modified Starch 2 | 27 | NS-1 | 3 |
| P19/10 | Corn Meal (for Tortillas & | Mexico | Potato Starch | 27 | NS-1 | 3 |
| | Tamales) | | | | | |
| P19/11 | Corn Meal (for Tortillas & | Mexico | Corn Starch | 27 | NS-1 | 3 |
| | Tamales) | | | | | |
| P19/12 | Wheat Flour | Coop | Potato Starch | 27 | NS-1 | 3 |
| P19/13 | Corn Starch pregelatinised | Roquette | — | — | NS-1 | 10 |
| P19/14 | Corn Meal (for Tortillas & | Mexico | — | — | NS-1 | 3 |
| | Tamales) | | | | | |
| P19/15 | Corn Meal (for Tortillas & | Mexico | — | — | NS-3 | 10 |
| | Tamales) | | | | | |
| P19/16 | Corn Meal (for Tortillas & | Mexico | — | — | NS-3 | 7 |
| | Tamales) | | | | | |
| P19/17 | Wheat Flour | Coop | — | — | NS-1 | 10 |
| P19/18 | Hard Wheat Grits | Migros | — | — | NS-1 | 10 |
| P19/19 | Rice Flour | Biofarm | — | — | NS-1 | 10 |
| P20/1 | Corn Flour | Asia | — | — | NS-1 | 7 |
| P20/2 | Potato Whole Meal | Biorex | — | — | NS-1 | 7 |
| P20/3 | Cassava Whole Meal | Asia | — | — | NS-1 | 7 |
| P20/5 | Rice Flour | Biofarm | — | — | NS-1 | 7 |
| P20/6 | Buckwheat Whole Meal | Holle | — | — | NS-1 | 7 |
| P20/7 | Roasted Mung Bean Whole | Sri Lanka | — | — | NS-1 | 7 |
| | Meal | | | | | |
| P20/8 | Palmroot Whole Meal | Sri Lanka | — | — | NS-1 | 7 |

TABLE 2
Mechanical properties in a tensile test (elasticity modulus (E), breaking
strength (s) and breaking elongation (e)) for pasta products made out
of various raw materials based on starch networks. The pasta products
were each swelled to equilibrium in excess water at 24° C. before
the tensile test. Wq is the water content after swelling (relative to
the respective moisture content). After similarly swelled, conventional
hard wheat has too low a strength to be analyzed in a tensile test.
Its elasticity modulus lies at <0.1 MPa.

| | | E | σ | ε | Wq |
|---|---|---|---|---|---|
| Nr. | Pasta Products from | [MPa] | [MPa] | [%] | [%] |
| | Hard Wheat Pasta | <0.1 | | <10 | 56 |
| P15/3 | Potato Starch | 7.3 | 1.3 | 31 | 45 |
| P15/4 | Corn Starch | 8.5 | 1.0 | 20 | 43 |
| P15/5 | Tapioca Starch | 10.8 | 1.5 | 20 | 40 |
| P17/1 | Potato Whole Meal | 6.0 | 1.1 | 32 | 50 |
| P19/1 | Potato Starch | 5.3 | 1.1 | 45 | 54 |
| P19/5 | Potato Starch | 7.0 | 1.6 | 42 | 51 |
| P19/6 | Corn Starch | 7.2 | 0.9 | 18 | 48 |
| P19/8 | Potato Whole Meal | 6.0 | 0.7 | 19 | 53 |
| P19/9 | Maranta/Tapioca Flour | 3.8 | 0.7 | 30 | 54 |
| P19/10 | Corn Meal | 5.8 | 0.7 | 19 | 52 |
| P19/11 | Corn Meal | 7.8 | 1.0 | 21 | 47 |
| P19/12 | Wheat Flour | 3.1 | 0.8 | 40 | 52 |
| P19/13 | Corn Starch | 9.9 | 1.4 | 25 | 45 |
| P19/14 | Corn Meal | 8.0 | 0.3 | 7 | 44 |
| P19/15 | Corn Meal | 8.3 | 0.6 | 12 | 49 |
| P19/16 | Corn Meal | 7.3 | 0.5 | 11 | 46 |
| P19/17 | Wheat Flour | 2.1 | 0.5 | 33 | 55 |
| P19/18 | Hard Wheat Grits | 4.5 | 0.7 | 22 | 53 |
| P19/19 | Rice Flour | 3.7 | 0.7 | 27 | 49 |

Pasta products based on starch networks behave in a fundamentally different manner than conventional hard wheat pasta (tagliatelle napoli, Coop) after swelling in water with respect to mechanical properties, with the pasta products according to the invention in particular exhibiting astoundingly high elasticity moduli and strengths in this state. Although the pasta products were not optimized to high mechanical properties after swelling, strengths of up to 2 MPa or more can be obtained, for example. However, such pasta products are still too hard even after prolonged boiling, and hence not suitable for this application.

TABLE 3
Influence of conditioning conditions on the mechanical properties
of elasticity modulus (E), breaking strength (s) and breaking elongation
(e) measured in the tensile test for pasta products made out of flours
of varying origin (procedural variant 3.2) based on a starch network
with 7% NS. Before the tensile test, the pasta products were swelled
to equilibrium for 24 h in excess water at 24° C. The elasticity
moduli specified with approx. are sensory estimates, as the corresponding
samples could not be analyzed in the tensile test due to too low of
a strength. Conventional hard wheat pasta also has too low of a strength
after similar swelling to be analyzed in the tensile test. Its elasticity
modulus lies at <0.1 MPa. Conditioning clearly has an in part considerable
influence on the mechanical properties. The corresponding differences
are rooted in various network densities. Surprisingly, clearly higher
elasticity moduli and strengths can be achieved even with full and
low quality raw meal than with conventional hard wheat pasta.

| | | E | σ | ε |
|---|---|---|---|---|
| Sample | Conditioning | [MPa] | [MPa] | [%] |
| Hard Wheat Pasta | | <0.1 | | |
| (Tagliatelle Napoli, | | | | |
| Coop) | | | | |
| P20/1: | A | ca. 1.0 | | |
| Corn Flour | B | 2.0 | 0.30 | 24 |
| (Asia) | D | 3.9 | 0.50 | 21 |
| | C | 5.6 | 0.68 | 22 |
| P20/2: | A | 4.9 | 0.55 | 21 |
| Potato Whole Meal | B | 6.1 | 0.64 | 17 |
| (Biorex) | D | 7.0 | 0.56 | 12 |
| | C | 6.3 | 0.56 | 16 |
| P20/3: | A | ca. 0.4 | | |
| Cassava Whole Meal | B | ca. 1.5 | | |
| (Asia) | D | ca. 1.5 | | |
| | C | 4.0 | 0.44 | 16 |
| P20/5: | A | ca. 0.1 | | |
| Rice Flour | B | ca. 0.5 | | |
| (Biofarm) | D | ca. 1.0 | | |
| | C | 2.8 | 0.33 | 20 |
| P20/6: | A | ca. 1.5 | | |
| Buckwheat Whole | B | ca. 2.0 | | |
| Meal | D | 2.0 | 0.28 | 23 |
| (Holle) | C | 3.3 | 0.42 | 22 |
| P20/7: | D | 3.9 | 0.12 | 7 |
| Roasted Mung Bean | | | | |
| Whole Meal (containing | | | | |
| fibers, Sri Lanka) | | | | |
| P20/8: | D | 7.9 | 0.37 | 8 |
| Palmroot Whole Meal | | | | |
| containing fibers, | | | | |
| Sri Lanka) | | | | |

Conditioning conditions: A=immediate drying in the atmosphere after manufacture; B=3 h of storage at a constant water content, then drying in the atmosphere; C=storage for 18 h at 3° C. at a constant water content, then drying in the atmosphere; D=storage for 18 h at 45° C. at a constant water content, then drying in the atmosphere.

### DESCRIPTION OF THE DRAWINGS

FIG. 1 shows the storage of pasta products made of varying raw materials based on starch networks (c)-i)) in water at room temperature in comparison with commercial hard wheat pasta a) and commercial corn pasta products b).

FIG. 2 shows the storage of pasta products made out varying raw materials based on starch networks j)-p)) in water at room temperature.

FIG. 3 shows the chewing consistency of high-strength pasta products based on starch networks in comparison with hard wheat pasta (napoli, Coop) and rice noodles (Banh Pho, Thailand). The measured chewing consistencies are clearly greater than for hard wheat pasta (HWP), and in particular for rice noodles (Banh Pho, Thailand). Such chewing consistencies exceed the desired level, or cooking times for the “al dente” state of about 15 min are necessary relative to the 6 to 8 min for hard wheat pasta and 6 min for rice noodles. However, the drawing clearly shows the potential with respect to the chewing consistency of pasta products based on starch networks, and indicates that there are basic difference between these pasta products and conventional pasta products.

FIG. 4 shows the chewing consistency of pasta products made out of corn flour based on the starch network in comparison with hard wheat pasta (HWP) and rice noodles. The measured chewing consistencies are clearly greater than for rice noodles (Banh Pho, Thailand), and can be set both higher (P19/10) and lower (P19/15) than for conventional hard wheat pasta (tagliatelle napoli, Coop, CH).

FIG. 5 shows the chewing consistency of pasta products made out of corn flour and corn starch based on the starch network. P19/3 was manufactured using pre-gelatinized corn starch (Roquette), and has no network according to the invention, as opposed to the other samples. P19/6 and P19/13 were also manufactured with pre-gelatinized corn starch (Roquette) (procedural variant 3.2). P19/10 and P19/15 were manufactured with corn flour for tortillas and tamales (Mexico) (procedural variant 3.1 and 3.2). P14/10 was manufactured with pre-cooked corn flour for arepas and empanadas (P.A.N., Venezuela) (procedural variant 3.1). The measured chewing consistencies of the pasta products according to the invention are clearly improved relative to those of P19/3. As also evident, the starch networks offer broad flexibility in adjusting the chewing consistency.

FIG. 6 shows the chewing consistency of pasta products made out of various starches based on the starch network as compared with hard wheat pasta (HWP) and rice noodles. The pasta products P15/3-P15/6 were manufactured according to procedural variant 3.1. The obtained chewing consistencies are clearly higher than for rice noodles (Banh Pho, Thailand), and could be set both higher and lower than the chewing consistency of hard wheat pasta (tagliatelle napoli, Coop). The examples show that pasta products according to the invention can be manufactured using various starches.

FIG. 7 shows the chewing consistency of pasta products made out of various flours based on the starch network as compared with hard wheat pasta (HWP) and rice noodles. The pasta products P19/8-P19/12 were manufactured according to procedural variant 3.1. The obtained chewing consistencies are clearly higher than for rice noodles (Banh Pho, Thailand), and could be set both higher and lower than the chewing consistency of hard wheat pasta (tagliatelle napoli, Coop). The examples show that pasta products according to the invention can be manufactured using various flours. The samples P19/11 and P19/12 indicate that pasta products based on the starch network can be obtained with a quasi-plateau for chewing consistency (from 20 to 30 min), i.e., pasta-products with an “al dente” consistency that persists even during prolonged boiling.

FIG. 8 shows the influence of conditioning prior to drying on the chewing consistency of pasta products made out of corn flour (fine cornmeal, Asia) based on the starch network with 7% NS (procedural variant 3.2). The sample P20/1 C indicates that a quasi-plateau of chewing consistency (from approx. 10 to 20 min) can be achieved using suitable conditioning conditions.

Conditioning conditions: A=immediate drying in the atmosphere after manufacture; B=3 h of storage at a constant water content, then drying in the atmosphere; C=storage for 1 8 h at 3° C. at a constant water content, then drying in the atmosphere; D=storage for 18 h at 45° C. at a constant water content, then drying in the atmosphere.

FIG. 9 shows the influence of conditioning prior to drying on the chewing consistency of pasta products made out of corn flour (fine cornmeal, Asia) based on the starch network with 7% NS (procedural variant 3.2) by comparison to hard wheat pasta (napoli, Coop). As evident, conditioning can greatly influence the chewing consistency, wherein higher chewing consistencies as for hard wheat pasta (HWP) can also be obtained. This is surprising, since pasta products with good chewing consistency is virtually impossible to manufacture out of raw meal, e.g., with buckwheat raw meal, using conventional methods.

Conditioning conditions: A =immediate drying in the atmosphere after manufacture; B=3 h of storage at a constant water content, then drying in the atmosphere; C=storage for 18 h at 3° C. at a constant water content, then drying in the atmosphere; D=storage for 18 h at 45° C. at a constant water content, then drying in the atmosphere.

FIG. 10 compares the chewing consistency for pasta products made out of soft wheat based on the starch network to hard wheat pasta (HWP) during storage in water at 70° C. after boiling beforehand for 10 min at 100° C. After 18 h of storage at 70° C. in water, the chewing consistency still measured roughly 25 g for hard wheat pasta, while P19/12 still had a chewing consistency of roughly 100 g.

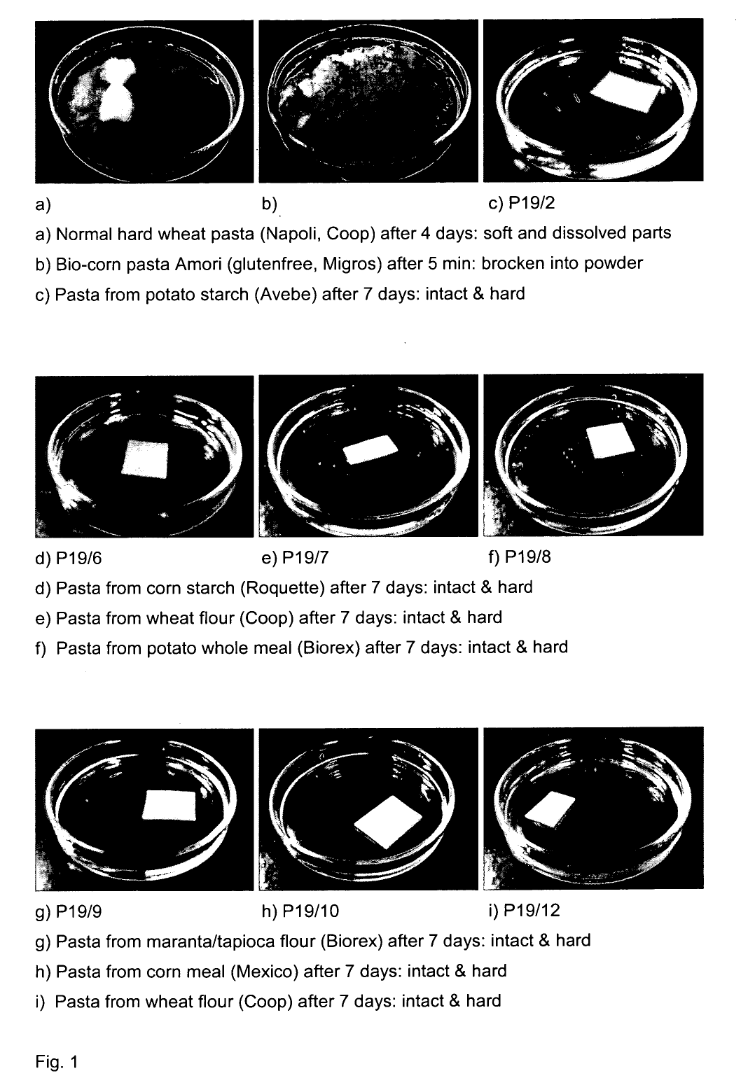

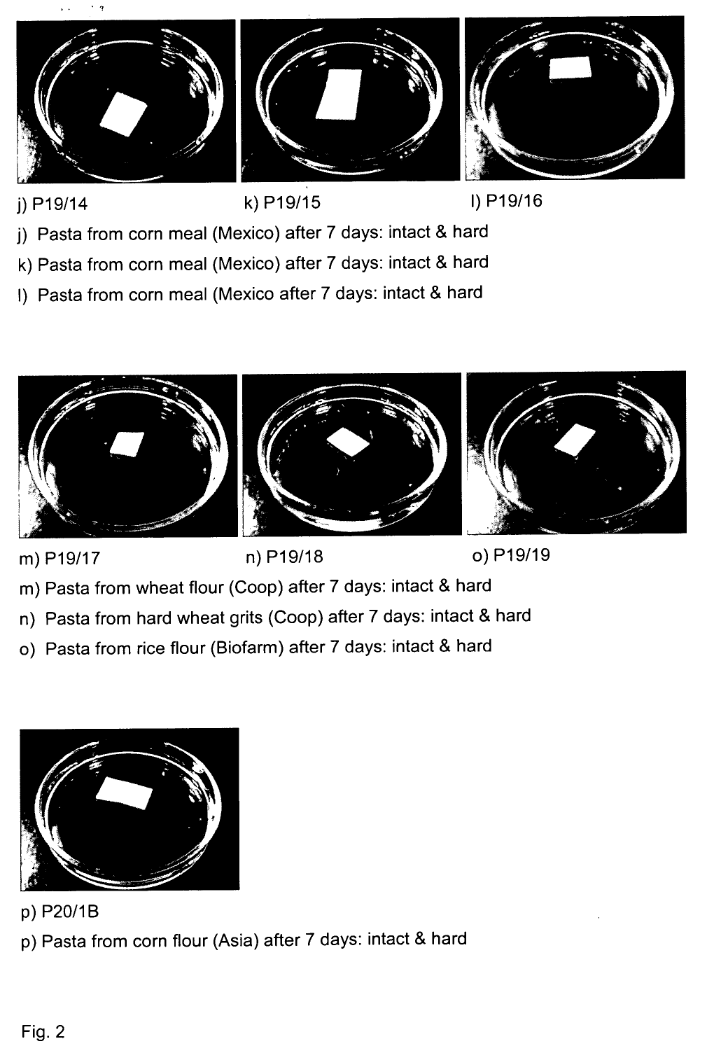

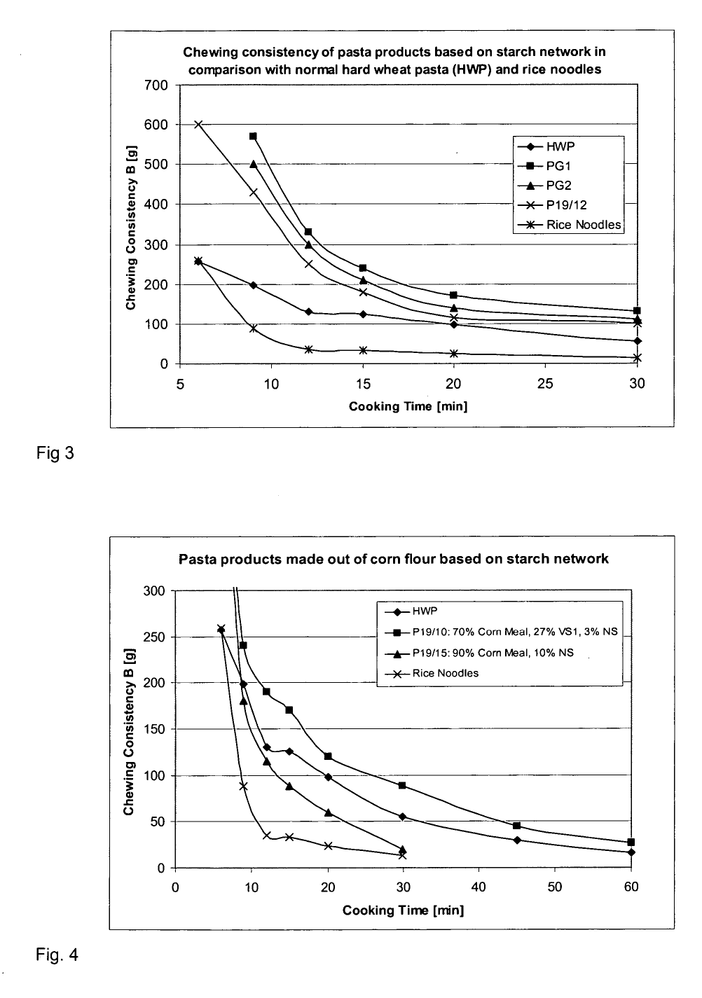

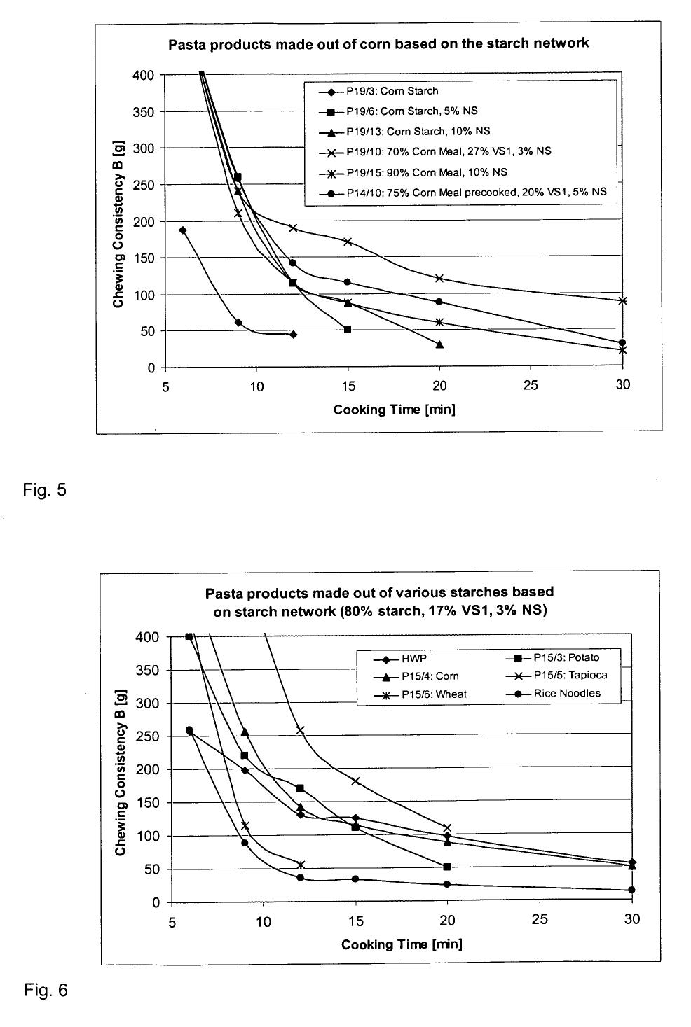

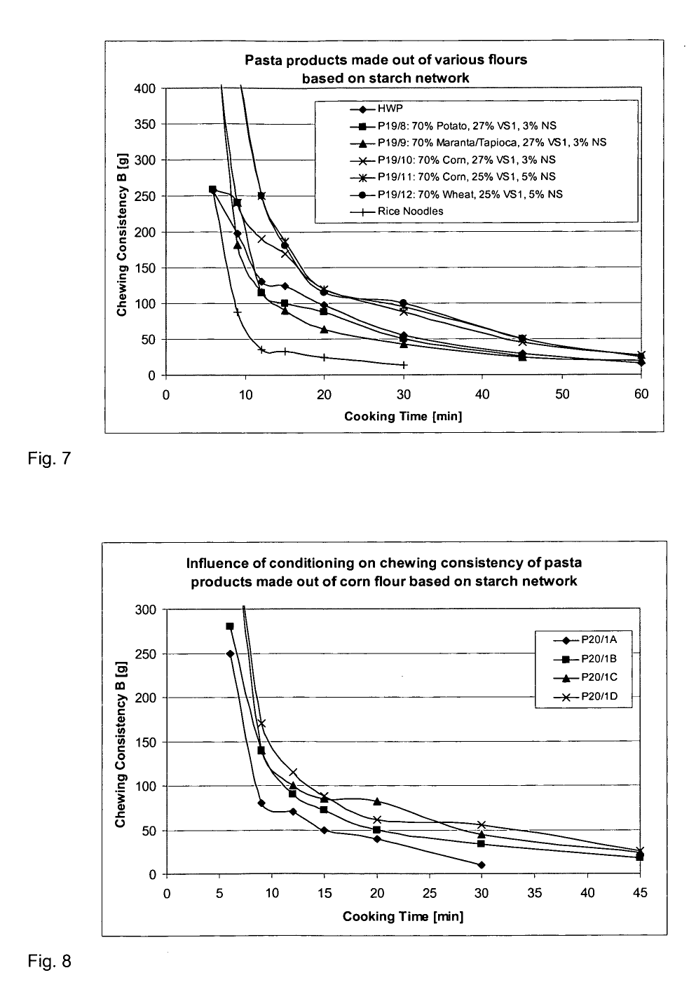

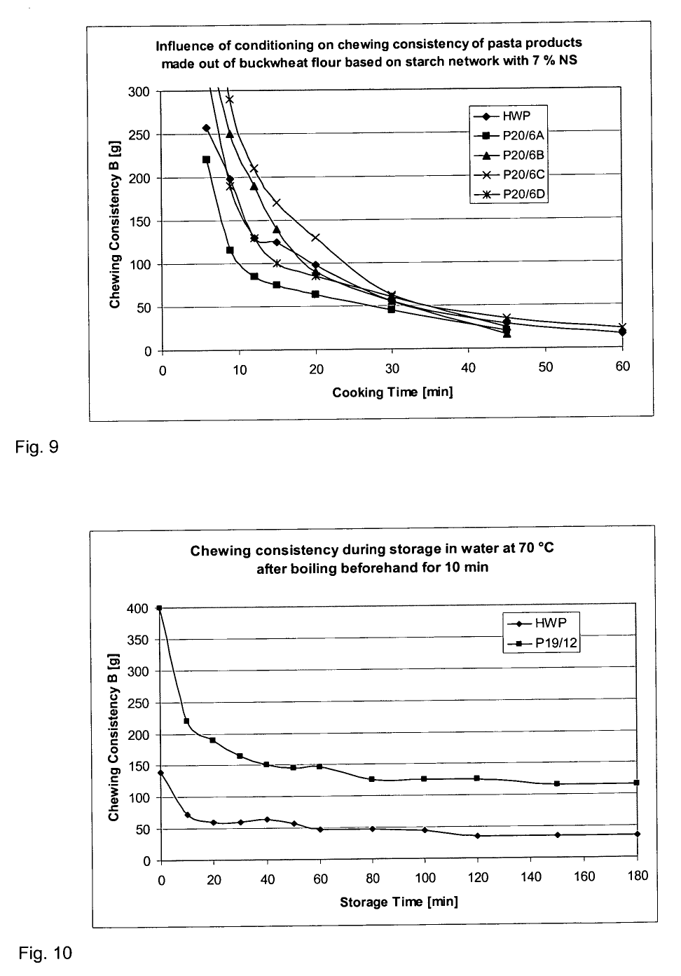

The chewing consistencies as a function of storage time reveal a surprisingly similar pattern for both pasta products with three quasi-plateaus, but the chewing consistency of pasta products based on the starch network had distinctly higher values. How chewing consistency behaves over longer storage periods is relevant for large kitchens and in the catering industry, for example, where the “al dente” state should preferably remain constant after boiling until consumption. In the case of pasta products based on the starch network, the advantage is that chewing consistency remains at a comparatively high level.

Symbols

RT: Room temperature
RH: [%], relative atmospheric humidity
d: Day
db: “dry basis”, dry weight
σ: [MPa], maximum strength in tensile test
ε_{b}: [%], breaking elongation in tensile test
Wq: [%], water content after swelling in excess water at RT after 24 h
S: [%], water solubility in relation to dry weight
B: [g], chewing consistency; chewing consistency was determined using a flat pasta sample, which had a thickness of about I mm before boiling. A bar 0.75 mm wide was paced on a sample 11 mm wide in the process. The chewing consistency was calculated as weight in g, wherein the sample was cut in two within 10 s. This test arrangement was well able to simulate chewing.
DPn: Polymerization level unit.

1. (canceled)

2. (canceled)

3. Food according to claim 15, wherein a portion of the starch in the matrix comes from the disperse phase.

4. (canceled)

5. (canceled)

6. Food according to claim 15, wherein after being manufactured, the food has a starch network comprised of macromolecules of the at least one NS component and the at least one VS component, wherein:
a) the percent by weight of the network in the foodstuff ranges from 0.1 to 100% db;
b) the percent by weight of the NS component(s) in the foodstuff ranges from 0.03 to 99% db;
c) the percent by weight of the NS component(s) in the network ranges from 0.03 to 99% db; and in particular; and
d) the network is coupled with at least one at least partially gelatinized or at least partially plasticized VS component.

7. (canceled)

8. Food according to claim 15, wherein proteins, in particular gluten or other polysaccharides than starch are contained in the network or matrix consisting entirely or partially of starch, wherein this phase consists in particular of interpenetrating networks.

9. Food according to claim 15, wherein in the absence of nuclei in excess water at RT after id, in particular after 3d, preferably after 7 d, most preferably after 14 d, the food:
a) has a strength σ in Mpa in a tensile test of >0.1, in particular >0.3, preferably >0.7, most preferably >1.1; and/or
b) an elasticity modulus E in Mpa in a tensile test of >0.5, in particular >1, preferably >3, most preferably >5; and/or
c) a water solubility S in % db of <3, in particular <1, preferably <0.5, most preferably <0.3.

10. Food according to claim 15, wherein because of the starch network, the food has a portion of resistant starch in [%] of >3, preferably >5, in particular >7, most preferably >10.

11. Food according to claim 5, wherein because of the starch network, the food has a glyceamic index reduced by a factor of <0.7, preferably <0.5, in particular <0.3, most preferably <0.1 contrasted to a comparable conventional food.

12. Food according to claim 15, wherein the food is present as a pasta product, in particular as dry goods, ready made fresh goods, in instant form or canned goods; as cereals, in particular as cereal flakes; as a snack; or as pastry.

13. Food according to claim 15, wherein in the absence of any admixed eggs or egg constituents, the pasta products in boiling water have:
a) a water solubility S of <5%, in particular <3%, preferably <2%, most preferably <1%, after 15 min;
and/or
b) a chewing consistency B in grams of >200, in particular >300, preferably >400, most preferably >500 after 6 min; and/or
c) a chewing consistency B in grams of >100, in particular >150, preferably >200, most preferably >300 after 10 m; and/or
d) a chewing consistency B in grams of >50, in particular >70, preferably >100, most preferably >130 after 30 m.

14. (canceled)

15. Food made of starch, flour, grits and the like, the food having a matrix formed by a starch network and a disperse phase, wherein:
a) the matrix has a networkable starch (NS) and a first primary starch (VS1), wherein VS1 is a primarily branched starch, and NS is a primarily linear starch with an amylose content >30%;
b) NS is present at least once in a state of largely released crystallization potential during food manufacture, and NS and VS1 were mixed in a molecularly disperse manner before the starch network was formed; and
c) the disperse phase has a second primary starch (VS2), which is any starch desired, and is present in a native state or in a partially to completely gelatinized state.

16. Method for manufacturing a food out of starch, flour, grits and the like, comprising:
a) converting a networkable starch (NS) into a state of largely released crystallization potential, wherein NS is a primarily linear starch with an amylose content>30%;
b) converting a first primary starch (VS1) into a solution or melt, wherein VS1 is a primarily branched starch;
c) manufacturing a molecularly disperse mixture of NS and VS1;
d) mixing a second primary starch (VS2) in the molecularly disperse mixture of NS and VS1, wherein VS2 is any starch desired;
e) initiating a network formation by homo- and/or heterocrystallization of NS and VS1 or NS and VS1 and a percentage of VS2; and
f) conditioning and/or drying, as required,
thereby yielding a product with VS2 as the disperse phase in a matrix comprised of the network, wherein VS2 is present in a native state or in a partially to completely gelatinized state.
